(19) United States
(12) Patent Application Publication
(10) Pub. No.: US 2026/0044950 A1
(43) Pub. Date: Feb. 12, 2026

(54) ALIGNING IMAGES OF DIFFERENT LAYERS ON A SPECIMEN

(71) Applicant: KLA Corporation, Milpitas, CA (US)

(72) Inventors: Prashant VERMA, Fremont, CA (US); Shoujing GUO, Mountain View, CA (US); Nurmohammed PATWARY, San Jose, CA (US); James A. SMITH, Los Altos, CA (US); Hong CHEN, San Ramon, CA (US); Xiaochun LI, San Jose, CA (US)

(21) Appl. No.: 19/278,750

(22) Filed: Jul. 23, 2025

Related U.S. Application Data
(60) Provisional application No. 63/681,885, filed on Aug. 12, 2024.

(51) Int. Cl. G06T 7/00; G06T 5/50; G06T 5/70; G06T 7/33; G06T 7/38

(52) U.S. Cl. CPC G06T 7/001; G06T 5/50; G06T 5/70; G06T 7/0006; G06T 7/337; G06T 7/38; G06T 2207/30148

(57) ABSTRACT

Methods and systems for aligning images of different layers on a specimen are provided. The embodiments may be particularly useful for singular value decomposition (SVD) based cross-layer alignment for defect detection. One system includes a computer subsystem configured for generating first and second SVD based noise images for first and second images, respectively, of first and second layers, respectively, on a specimen. The first layer is formed subsequent to formation of the second layer on the specimen. The computer subsystem is also configured for computing one or more global offsets by aligning the first SVD based noise images to the second SVD based noise images, applying the one or more global offsets to the second images to thereby align the second images to the first images, and determining information for the specimen based on the aligned first and second images.

### BACKGROUND OF THE INVENTION

### 1. Field of the Invention

The present invention generally relates to methods and systems for aligning images of different layers on a specimen. Certain embodiments relate to singular value decomposition (SVD) based cross-layer image alignment for applications such as inspection.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on wafers to promote higher yield in the manufacturing process and thus higher profits. Inspection has always been an important part of fabricating semiconductor devices such as ICs. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on the wafer where defects have been detected by inspection. The higher resolution data for the defects generated by defect review is more suitable for determining attributes of the defects such as profile, roughness, more accurate size information, etc.

Metrology processes are also used at various steps during a semiconductor manufacturing process to monitor and control the process. Metrology processes are different than inspection processes in that, unlike inspection processes in which defects are detected on a wafer, metrology processes are used to measure one or more characteristics of the wafer that cannot be determined using currently used inspection tools. For example, metrology processes are used to measure one or more characteristics of a wafer such as a dimension (e.g., line width, thickness, etc.) of features formed on the wafer during a process such that the performance of the process can be determined from the one or more characteristics. In addition, if the one or more characteristics of the wafer are unacceptable (e.g., out of a predetermined range for the characteristic(s)), the measurements of the one or more characteristics of the wafer may be used to alter one or more parameters of the process such that additional wafers manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a wafer may be independent of the results of an inspection process performed on the wafer. In particular, the locations at which a metrology process is performed may be selected independently of inspection results. In addition, since locations on the wafer at which metrology is performed may be selected independently of inspection results, unlike defect review in which the locations on the wafer at which defect review is to be performed cannot be determined until the inspection results for the wafer are generated and available for use, the locations at which the metrology process is performed may be determined before an inspection process has been performed on the wafer.

One of the challenges of many of the methods described above, and particularly inspection, is aligning the image being used to determine information for a specimen and some reference image. For example, in the case of inspection methods, the test image, which is being examined for the presence of defects, is aligned to some reference image, whether that is an image generated from the specimen or a database. The images may then be compared, e.g., by subtracting the reference image from the test image, to thereby identify differences between the images. The differences can then be compared to a defect detection threshold to determine if they correspond to defect candidates. Therefore, proper alignment of the test image to the reference image can have a significant impact on inspection, e.g., leading to erroneous defect detection if not performed correctly.

Aligning images generated for the same layer on the specimen can be difficult, e.g., due to process variation between dies. Aligning images generated for different layers on a specimen can present even more challenges, e.g., since different layers undergo different processes, alignment can become more challenging than just alignment within a layer. For example, currently used alignment methods and algorithms often use normalized cross-correlation (NCC) between test images for aligning the frames within a job. Test images from two different layers can have different features and patterns. Hence, currently used test image-based alignment can be challenging due to relatively low image to image correlation and often fail leading to relatively poor cross-layer alignment and therefore poor inspection results generated from the poorly aligned images. Repeating patterns in the test images can pose additional challenges for test image-based alignment.

Accordingly, it would be advantageous to develop systems and methods for aligning images of different layers of a specimen that do not have one or more of the disadvantages described above.

### SUMMARY OF THE INVENTION

The following description of various embodiments is not to be construed in any way as limiting the subject matter of the appended claims.

One embodiment relates to a system configured for aligning images of different layers on a specimen. The system includes an imaging subsystem configured to generate first and second images of first and second layers, respectively, on a specimen. The first layer is formed on the specimen subsequent to formation of the second layer on the specimen. The system also includes a computer subsystem configured for generating first and second singular value decomposition (SVD) based noise images for the first images and the second images, respectively. The computer subsystem is also configured for computing one or more global offsets by aligning the first SVD based noise images to the second SVD based noise images, applying the one or more global offsets to the second images to thereby align the second images to the first images, and determining information for the specimen based on the aligned first and second images. The system may be further configured as described herein.

Another embodiment relates to a computer-implemented method for aligning images of different layers on a specimen. The method includes acquiring first and second images generated by an imaging subsystem of first and second layers, respectively, on a specimen. The first layer is formed on the specimen subsequent to formation of the second layer on the specimen. The method also includes the generating, computing, applying, and determining steps described above. The steps of the method are performed by a computer subsystem coupled to the imaging subsystem configured as described above.

Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for aligning images of different layers on a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a schematic diagram illustrating a cross-sectional view of an example of a specimen on which a first layer is formed subsequent to formation of a second layer on the specimen;

FIG. 4 is a flow chart illustrating an embodiment of steps that may be performed by the embodiments described herein for aligning images of different layers on a specimen to each other;

FIG. 5 is a schematic diagram illustrating examples of images at different steps of an embodiment of aligning images of different layers on a specimen; and

FIG. 6 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

One embodiment relates to a system configured for aligning images of different layers on a specimen. Some embodiments are related to singular value decomposition (SVD) based cross-layer alignment for applications such as inspection. The embodiments described herein are particularly advantageous for addressing challenges related to alignment of broadband plasma (BBP) test images.

Noise-based alignment is a robust approach for such cases since wafer noise can be correlated between two layers, which is a working prerequisite for cross-layer inspection itself. Difference images currently used for defect detection in inspection tools may be obtained by computed reference processing or a simple die-to-die subtraction, depending on the defect detection algorithm being used for inspection. Assuming these difference images are dominated by wafer noise, they can be used as a surrogate for noise images to perform cross-layer alignment.

Generating difference images has a prerequisite to align 1) the test images within the current layer to a current layer reference and 2) the test images within the prior layer to a prior layer reference, which can be challenging for cases such as process variation, repeating or one-dimensional patterns, etc. Additionally, the presence of a medium to large sized defect in difference images can lead to misalignment due to relatively low correlation. Another caveat is that computed reference processing requires at least a few frames from different dies to compute a clean difference image. This requirement can be problematic in case of top and bottom die rows with substantially fewer dies. Difference images can also suffer from artifacts and uncorrelated noise due to factors such as saturation, process variation, and color variation in test images that can lead to suboptimal performance of noise-based alignment. The embodiments described herein are configured for performing cross-layer image alignment without any such disadvantages.

The terms “first” and “second” are used herein only to differentiate between different things, e.g., different images, different specimen layers, etc. These terms are not meant to indicate any other preferential, spatial, temporal, or other characteristics of the elements. In addition, although some embodiments may be described with respect to first and second elements, like first and second images, the embodiments are not limited to only two of any one element. For example, although some embodiments may be described with respect to first and second images, they may also be performed for third and fourth images and so on.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

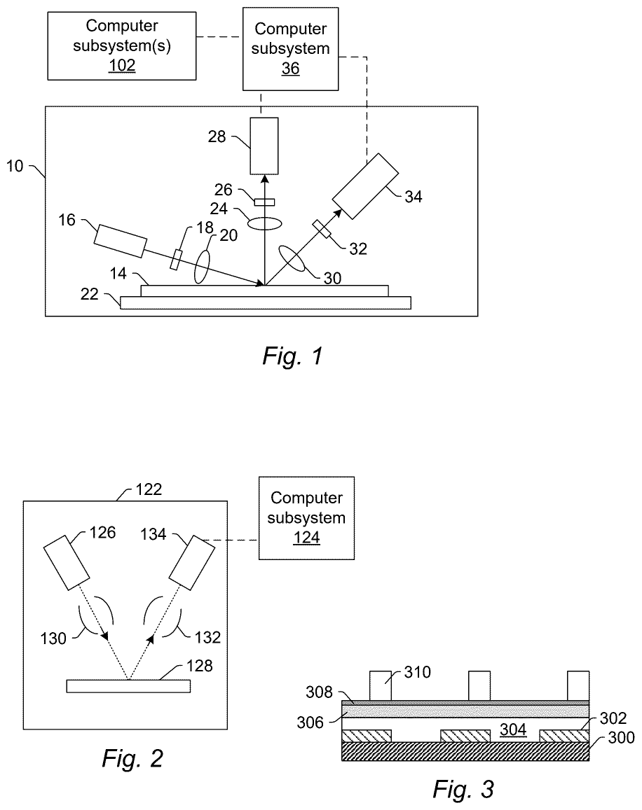

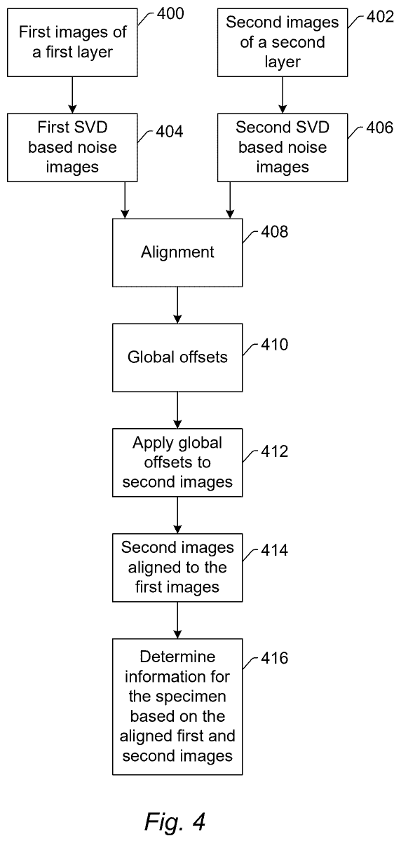

One embodiment of a system configured for detecting defects on a specimen is shown in FIG. 1. The system includes imaging subsystem 10 configured to generate first and second images of first and second layers, respectively, on a specimen. For example, as shown in FIG. 4, the imaging subsystem may generate first images 400 of a first layer on a specimen and second images 402 of a second layer on the specimen. In FIG. 1, the imaging subsystem is configured as a light-based inspection subsystem and in some embodiments as a broadband (BB) light-based imaging subsystem. However, the imaging subsystem may be configured as an electron beam or charged particle beam based imaging subsystem.

In general, the imaging subsystems described herein include at least an energy source and a detector. The energy source is configured to generate energy that is directed to a specimen. The detector is configured to detect energy from the specimen and to generate output responsive to the detected energy.

In a light-based imaging subsystem, the energy directed to the specimen includes light, and the energy detected from the specimen includes light. For example, as shown in FIG. 1, the imaging subsystem includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the defects to be detected on the specimen.

The illumination subsystem may be configured to direct the light to the specimen at different angles of incidence. For example, the imaging subsystem may be configured to alter one or more characteristics of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include BB light. However, the light source may include any other suitable light source such as any suitable laser known in the art configured to generate light at any suitable wavelength(s) known in the art. In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more of the elements of the illumination subsystem based on the type of illumination to be used for imaging.

The imaging subsystem may also include a scanning subsystem configured to change the position on the specimen to which the light is directed and from which the light is detected and possibly to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging subsystem may be configured such that one or more optical elements of the imaging subsystem perform some scanning of the light over the specimen such that the light can be directed to and detected from different positions on the specimen. The light may be scanned over the specimen in any suitable fashion such as in a serpentine-like path or in a spiral path.

The imaging subsystem further includes one or more detection channels. At least one of the detection channel(s) includes a detector configured to detect light from the specimen due to illumination of the specimen by the system and to generate output responsive to the detected light. The imaging subsystem shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging subsystem that includes two detection channels, the imaging subsystem may include a different number of detection channels (e.g., only one detection channel or two or more detection channels). The detection channel formed by collector 30, element 32, and detector 34 may form one side channel as described above, and the imaging subsystem may include an additional detection channel (not shown) formed as another side channel that is positioned on the opposite side of the plane of incidence. Therefore, the imaging subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging subsystem may also include two or more side channels configured as described above. As such, the imaging subsystem may include at least three channels (i.e., one top channel and two side channels), and each of the at least three channels is configured to collect light at different scattering angles than each of the other collectors.

As described further above, one or more of the detection channels may be configured to detect scattered light. Therefore, the imaging subsystem shown in FIG. 1 may be configured for dark field (DF) imaging of specimens. However, the imaging subsystem may also or alternatively include detection channel(s) that are configured for bright field (BF) imaging of specimens. Therefore, the imaging subsystems described herein may be configured for only DF, only BF, or both DF and BF imaging. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors in each of the detection channels may be signals or data, but not image signals or image data. In such instances, a computer subsystem may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

Computer subsystem 36 may be coupled to the detectors of the imaging subsystem in any suitable manner (e.g., via one or more transmission media, which may include “wired” and/or “wireless” transmission media) such that the computer subsystem can receive the output generated by the detectors. Computer subsystem 36 may be configured to perform a number of functions using the output of the detectors as described further herein. Computer subsystem 36 may be further configured as described herein.

Computer subsystem 36 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) may also include any suitable processor known in the art such as a parallel processor. In addition, the computer subsystem(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 36 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

Although the imaging subsystem is described above as being an optical or light-based imaging subsystem, the imaging subsystem may be configured as an electron beam based imaging subsystem. In an electron beam imaging subsystem, the energy directed to the specimen includes electrons, and the energy detected from the specimen includes electrons. In one such embodiment shown in FIG. 2, the imaging subsystem includes electron column 122, and the system includes computer subsystem 124 coupled to the imaging subsystem. Computer subsystem 124 may be configured as described above. In addition, such an imaging subsystem may be coupled to another one or more computer subsystems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam inspection subsystem may be configured to use multiple modes to generate output for the specimen as described further herein (e.g., with different illumination angles, collection angles, etc.). The multiple modes of the electron beam imaging subsystem may be different in any output generation parameters of the imaging subsystem.

Computer subsystem 124 may be coupled to detector 134 as described above. The detector may detect electrons returned from the surface of the specimen thereby forming electron beam images of (or other output for) the specimen. The electron beam images may include any suitable electron beam images. Computer subsystem 124 may be configured to perform any step(s) described herein. A system that includes the imaging subsystem shown in FIG. 2 may be further configured as described herein.

FIGS. 1 and 2 are provided herein to generally illustrate configurations of an imaging subsystem that may be included in the system embodiments described herein. Obviously, the imaging subsystem configuration described herein may be altered to optimize the performance of the imaging subsystem as is normally performed when designing a commercial imaging system. In addition, the systems described herein may be implemented using an existing imaging system (e.g., by adding functionality described herein to an existing imaging system) such as the tools that are commercially available from KLA Corp., Milpitas, Calif. For some such systems, the methods described herein may be provided as optional functionality of the imaging system (e.g., in addition to other functionality of the imaging system). Alternatively, the imaging system described herein may be designed “from scratch” to provide a completely new imaging system.

Although the imaging subsystem is described above as being a light or electron beam imaging subsystem, the imaging subsystem may be an ion beam imaging subsystem. Such an imaging subsystem may be configured as shown in FIG. 2 except that the electron beam source may be replaced with any suitable ion beam source known in the art. In addition, the imaging subsystem may include any other suitable ion beam system such as those included in commercially available focused ion beam (FIB) systems, helium ion microscopy (HIM) systems, and secondary ion mass spectroscopy (SIMS) systems.

The imaging subsystem may be configured to generate output, e.g., images, of the specimen with multiple modes. In general, a “mode” is defined by the values of parameters of the imaging subsystem used for generating images of a specimen (or the output used to generate images of the specimen). Therefore, modes may be different in the values for at least one of the parameters of the imaging subsystem (other than position on the specimen at which the output is generated). For example, the modes may be different in any one or more alterable parameters (e.g., illumination polarization(s), angle(s), wavelength(s), etc., detection polarization(s), angle(s), wavelength(s), etc.) of the imaging subsystem. The imaging subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

The imaging subsystems described herein and shown in FIGS. 1 and 2 may be modified in one or more parameters to provide different imaging capability depending on the application for which they will be used. In one such example, the imaging subsystem shown in FIG. 1 may be configured to have a higher resolution if it is to be used for defect review or metrology rather than for inspection. In other words, the embodiments of the imaging subsystems shown in FIGS. 1 and 2 describe some general and various configurations for an imaging subsystem that can be tailored in a number of manners that will be obvious to one skilled in the art to produce imaging subsystems having different imaging capabilities that are more or less suitable for different applications.

As noted above, the imaging subsystem is configured for scanning energy (e.g., light, electrons, etc.) over a physical version of the specimen thereby generating output for the physical version of the specimen. In this manner, the imaging subsystem may be configured as an “actual” subsystem, rather than a “virtual” subsystem. However, a storage medium (not shown) and computer subsystem(s) 102 shown in FIG. 1 may be configured as a “virtual” system. In particular, the storage medium and the computer subsystem(s) may be configured as a “virtual” imaging system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., which are incorporated by reference as if fully set forth herein. The embodiments described herein may be further configured as described in these patents.

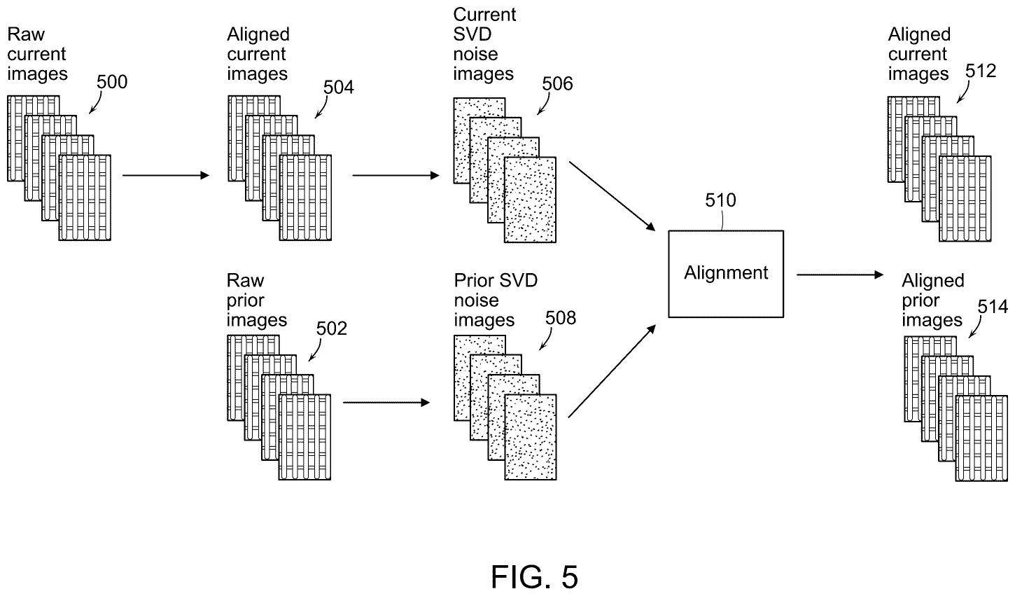

FIGS. 4 and 5 illustrate embodiments of SVD based cross-layer alignment workflows. As described above, the imaging subsystem is configured to generate first and second images of first and second layers, respectively, on a specimen. In particular, as shown in FIG. 4, the imaging subsystem is configured to generate first images 400 of a first layer on the specimen and second images 402 of a second layer on the specimen. As shown in FIG. 5, the imaging subsystem may be configured to generate raw current images 500 and raw prior images 502 for first and second layers on a specimen, respectively. In other words, raw current images are for the current layer on the specimen, meaning the uppermost and generally the last layer formed prior to imaging. The raw prior images are for a layer formed on the specimen prior to the current layer, i.e., the second layer.

In general, the current and prior images used in the embodiments described herein are “raw” in that they are the images generated by the detector with little to no image processing performed thereon. One reason why the images are raw images, rather than processed images, is that the embodiments described herein rely on correlation between noise in the images for alignment. Therefore, although most processes like inspection and others described herein often try to reduce noise before any other image processing so that the noise doesn't interfere with the results, the embodiments described herein take advantage of that noise and its correlation for image alignment. In this manner, the images input to the embodiments described herein may not have any image processing performed on them, but especially no image processing that would reduce the noise in the images.

Although a particular number of current and prior images are shown in FIG. 5, the imaging subsystem may generate any number of images for the current and prior layers, which may vary depending on the specimen and the process for which the images are being generated. None of the images shown in FIG. 5 are meant to be representative of any actual images of any actual specimen that may be generated by the embodiments described herein. Instead, the images are included here to only show basic differences between the images input to the embodiments (as well as after different steps in the embodiments) and to promote understanding of the embodiments. The images that are generated by the imaging subsystem will vary depending on the configuration of the imaging subsystem used for generating the images, the specimen and the patterns formed thereon, etc. The imaging subsystem may be configured for generating the images as described further herein.

The first layer is formed on the specimen subsequent to formation of the second layer on the specimen. In other words, the second layer may be formed on the specimen in one or more process steps, and then (possibly after one or more other intervening process steps) the first layer is formed on the specimen in another one or more process steps. In some cases, the process steps used to form the first and second layers may be the same types of process steps, e.g., when the first and second layers both contain patterned features that are formed by a combination of lithography and etch and possibly other steps. However, the first and second layers are formed in separate processes that may have one or more different parameters even if they are the same type(s) of processes. In other words, the process step(s) used to form the second layer do(es) not also form the first layer on the specimen (or vice versa).

In one embodiment, the second layer is formed under the first layer. In other words, the first and second layers are not formed on the same specimen plane. For example, the first and second layers are not formed in a multi-step lithography process in which, during a first lithography step, first patterned features are printed on a layer of a specimen and then, during a second lithography step, second patterned features are printed on the same layer of the specimen. Instead, the embodiments described herein are configured for aligning images from different layers, one formed under another, based on noise in the images since the noise may be correlated in the images of the different layers. In one such example, noise in an image of the second, underlying layer in one specimen location may be correlated to noise in an image of the first, overlying layer in the same specimen location. Such noise correlation may occur when, for instance, the second layer has some impact on the images of the first layer. For example, some imaging subsystems such as the BB light-based imaging subsystems described herein will generate images that are responsive to one or more underlying layers. Therefore, noise in the images previously generated for the one or more underlying layers can be used to align those images to the images of the overlying layers for the reasons described further herein.

FIG. 3 shows one non-limiting example of a specimen on which examples of the layers described herein are formed. This figure is not meant to represent any specific specimen for which the embodiments described herein may be useful. In addition, the specimen shown in this figure is not meant to show any limitations for the specimens for which the embodiments described herein can be used. In other words, as long as the noise in images of different layers on a specimen is at least partially correlated, the embodiments described herein may be used for aligning those images to each other.

In the example shown in FIG. 3, the specimen includes substrate 300, which may include simply the wafer substrate, but possibly one or more other layers (not shown) formed on the substrate and under the second layer. The second layer in this case includes patterned features 302 and possibly material 304 formed thereon. Patterned features 302 may be, for example, interconnect structures and material 304 may be a dielectric material. Material 304 may also include multiple materials (not shown). The imaging subsystem may generate the second images by scanning the specimen after patterned features 302 are formed and/or after material 304 is deposited (and possibly planarized) over the patterned features.

One or more additional layers such as thin films 306 and 308 may then be formed on material 304. These thin films may not be patterned but may have other purposes such as insulation, promoting the formation of patterned features 310 on the first layer (e.g., as in an anti-reflective coating), etc. In addition, although two thin films are shown in FIG. 3, the specimen may include none of such thin films or one or more thin films, other unpatterned material layers, and the like. Patterned features 310 may then be formed in one or more processing steps such as lithography and possibly etch, after which first images may be generated by the imaging subsystem as described herein.

As shown in FIG. 3, therefore, the second layer may be formed under the first layer even if patterned features on the second layer are not entirely formed under patterned features on the first layer. In addition, although FIG. 3 shows some spatial alignment between the right edges of the patterned features on the first and second layers, any such patterned feature alignment is not required for the embodiments described herein. For example, the patterned features on the first and second layers may have no overlap at all with one another, or if the period of the patterned features on the first and second layers is different enough, some of the patterned features on the second layer may be formed directly under the patterned features on the first layer while others are not. Furthermore, although the patterned features on the second layer are shown to have the same characteristics as each other and the patterned features on the first layer are shown to have the same characteristics as each other, this is not a requirement either. An entire die area on a specimen generally includes different patterned features having different characteristics. In another example, the first and/or second layers may include logic regions in which patterned features having different characteristics are certainly possible. Again, the patterned feature characteristics of the patterned features on the different layers whose images are being aligned are not important as long as the noise in the images of the different layers is correlated in some manner.

The imaging subsystem may be configured for generating the first and second images after the first and second layers, respectively, have been formed on the specimen. In other words, after the second layer has been formed on the specimen and prior to formation of the first layer on the specimen, the imaging subsystem may generate the second images by scanning the second layer or otherwise generating the second images as described herein. Then, after the first layer has been formed on the same specimen subsequent to formation of the second layer on the specimen, the imaging subsystem may again scan the specimen to generate the first images for the first layer. In this manner, the imaging subsystem may generate the first and second images at different times, i.e., after the second layer has been formed on the specimen and then after the first layer has been formed on the specimen.

The exact same imaging subsystem hardware may be used for generating both the first and second images, but possibly with one or more different parameters (e.g., tuned to the characteristics of the first and second layers, respectively). However, the imaging subsystem may actually include multiple imaging tools, that may or may not be part of the same system. One of the tools may be configured for generating the first images, and another of the tools may be configured for generating the second images. Although the images will most likely be generated by the same imaging subsystem, aligning images of different layers on the specimen generated by different tools may be another new application provided by the embodiments described herein. For example, if the first and second images from different tools have noise that is correlated in the same manner as described herein, the embodiments described herein can align those images based on noise as described herein.

If the first and second images are generated by different tools, the different tools may be preferably configured to generate the images with certain image characteristics that are the same, or substantially the same. One example of such an image characteristic that may make the embodiments described herein easier to use for such images is pixel size. In other words, the specimen scale in the different images is preferably the same or substantially the same. If the first and second images cannot be generated by different tools with such similar image characteristics, image processing may be performed prior to the steps described herein to alter one of the images so that its image characteristics are more similar to the other of the images to which it is being aligned. Preferably, such image processing does not, however, alter the noise in the images since that noise is used herein for image alignment.

In this manner, the term “imaging subsystem” as used herein generally refers to any and all of the elements that are configured and used to generate the first and second images. The elements included in the imaging subsystem may actually be included in different tools. The different tools may have similar or different configurations. In addition, the different tools may be configured for generating the images with the same type of energy or different types of energy. For example, the first images may be generated by a BB light-based imaging subsystem as shown in FIG. 1, and the second images may be generated by an electron beam imaging subsystem as shown in FIG. 2. In another example, the first images may be generated by a BB light-based imaging subsystem as shown in FIG. 1, and the second images may be generated by a different (e.g., non-BB) light-based imaging subsystem (not shown) that may be configured for BB light imaging or a different type of light imaging. Generally, how the different images for the different layers are generated is not important as long as the noise in the different images correlates to at least some degree.

The imaging subsystem may also be a virtual imaging subsystem configured as described above. In this manner, one or more tools may actually generate the first and second images using the physical version of the specimen after the first and second layers have been formed on the specimen, respectively, and may store the images as described herein. A virtual imaging subsystem may then acquire the first and second images from the storage medium, and then the computer subsystem may perform the steps described herein to align the first and second images to each other and to determine information for the specimen based on the aligned first and second images. In this manner, the embodiments described herein may not actually generate the images from the physical version of the specimen. Instead, another method or system may generate the first and second images from the specimen and store the first and second images, and then the embodiments described herein may simply acquire the first and second images from the storage medium. As such, the embodiments described herein may not include any elements that are configured for directing energy to and detecting energy from a specimen. The embodiments may therefore be implemented off-line or off-tool in that they do not need to be performed while a specimen is being scanned with energy while detecting energy therefrom.

In another embodiment, the second layer contributes to noise in the first images. In an additional embodiment, noise in the first images is correlated with noise in the second images. For example, as described herein, the embodiments perform image alignment for images from different layers on a specimen based on noise that is at least partially correlated in the different images. One way that the noise in the first layer images may be correlated to noise in the second layer images is if the noise in the second layer images contributes to (e.g., causes) at least some noise in the first images. In other words, noise at one location in a second layer image may also cause (at least some) noise in the same location in a first layer image. So, the noise from the prior layer may show up on the current layer to some extent, which makes the two layer noise correlated with each other. The second layer does not necessarily have to contribute to noise in the first layer images for the first and second layer images to have noise that is correlated. For example, it is possible that there are noise sources on the specimen that cause noise in both the first and second layer images. For the embodiments described herein, the source of the noise is not important as long as the noise is correlated between the first and second layer images.

In one embodiment, the first and second images include images of different patterned features on the specimen having at least one different patterned feature characteristic in addition to being formed on different layers of the specimen. For example, as shown in FIG. 3, patterned features 302 on the second layer of the specimen have one or more different patterned feature characteristics than patterned features 310 on the first layer of the specimen. In this example, the patterned feature characteristics of the patterned features on the first and second layers that are different include height, width, and period. Additional characteristics of the patterned features that may be different between the first and second layers include, but are not limited to, different material(s) of which they are formed, roughness characteristics, orientation, and the like.

In other words, if the first and second layers both contain patterned features, the patterned features on both layers may have one or more different patterned feature characteristics (and possibly even substantially different characteristics). Since the embodiments described herein rely on noise correlations between images of different layers on the specimen and repeating patterns can be effectively eliminated by the SVD alignment steps described herein, the embodiments described herein will be effectively (or at least substantially) immune to any differences between the patterned features (if any) formed on the different layers. In addition, different layers on a specimen may have correlated noise, even if the patterns themselves on the different layers have one or more different patterned feature characteristics. Therefore, the embodiments described herein may be widely applicable to any specimens having any patterned features formed on the different layers and provide more flexibility for specimens that are designed to have different patterned features on the different layers.

The system also includes a computer subsystem configured for generating first and second SVD based noise images for the first images and the second images, respectively. For example, as shown in FIG. 4, the computer subsystem generates first SVD based noise images 404 from first images 400 of a first layer. The computer subsystem also generates second SVD based noise images 406 from second images 402 of a second layer. In another example, as shown in FIG. 5, the computer subsystem generates current SVD noise images 506 (i.e., the first SVD based noise images) from raw current images 500 (i.e., the first images) or the aligned current images 504 when the first images are aligned as described herein prior to SVD. In addition, the computer subsystem generates prior SVD noise images 508 (i.e., second SVD based noise images) from raw prior images 502 (i.e., the second images). In this manner, the computer subsystem separately generates SVD based noise images for the first and second images using only the images from the first and second layers, respectively. In other words, the second images are not used to generate the first SVD based noise images, and the first images are not used to generate the second SVD based noise images.

In one embodiment, generating the first and second SVD based noise images removes medium-sized or larger defects in the first and second images from the first and second SVD based noise images, respectively. In other words, SVD can remove medium to large size defects from resulting noise images that have the potential to cause misalignment in currently used difference image-based alignment. “Medium-sized or larger” defects as that term is used herein is defined as defects that are non-negligible and have at least one dimension that is, for example, on the order of at least one-eighth the size of the patterned features on the layers. In this manner, what qualifies as a “medium-sized or larger” defect may not be noise or nuisance, but a defect size on the order of a size of a defect of interest (DOI) for the respective specimen layer. In addition, what qualifies as a “medium-sized or larger” defect may vary depending on the specimen and the patterned feature dimensions of the layers formed on the specimen. In general, therefore, the SVD performed by the embodiments described herein to generate the first and second SVD based noise images may advantageously remove signals from the images that are large enough to otherwise interfere with currently performed cross-layer alignment.

In another embodiment, generating the first and second SVD based noise images removes repeating patterns in the first and second images from the first and second SVD based noise images, respectively. For example, as described further herein, SVD may be used to preprocess the images and therefore improve the success rate of alignment. In general, SVD decomposes a matrix into orthogonal components with which optimal sub-rank approximations can be obtained. The largest object components in an image found using SVD generally correspond to eigen-images associated with the largest singular values, while image noise corresponds to eigen-images associated with the smallest singular values. Therefore, SVD can be a particularly useful tool for separating noise from patterned feature images in the embodiments described herein. Unlike many cases in which SVD is performed, however, the embodiments described herein are configured for retaining noise while removing patterned feature signals from the images.

In this manner, one advantage and improvement of the embodiments described herein over other cross-layer alignment methods is that they can handle repeating patterns in the test images, i.e., so any repeating patterns in the test images do not interfere with or complicate the alignment process. For example, generating low ranking images using SVD as described herein before alignment may remove non-matching and/or repeating features. The embodiments described herein will therefore be particularly advantageous in applications when image patterns in the images being aligned are different (or even the same) but noise is correlated.

In one such example, as shown in FIG. 5 by comparing current SVD noise images 506 to aligned current images 504 (and raw current images 500) and comparing prior SVD noise images 508 to raw prior images 502, the current and prior SVD noise images do not contain signals from the patterned features that are in the raw (and aligned) current images and the raw prior images. In other words, the repeating darker and lighter areas in the raw current and prior layer images are not in the current and prior SVD noise images. The SVD described herein removes the top k singular values (or diagonal elements of matrix Σ) from the images thereby reconstructing a reduced version of matrix A, which can then be used to generate noise images that are then essentially “low ranking” images, i.e., when some SVD components are removed from the images as described herein, they may be referred to as low rank images because higher rank eigenvectors have been removed. These low ranking images therefore contain mostly noise and are therefore particularly useful for performing cross-layer alignment for the reasons described herein.

Although the current and prior SVD noise images that are shown in FIG. 5 are useful for illustrating differences between the SVD noise based images and the original images, the current and prior SVD based noise images shown in this figure are not meant to represent any actual SVD based noise images that may be generated by the embodiments described herein. Instead, all of the images shown in FIG. 5 are merely meant to promote understanding of the embodiments described herein.

In some embodiments, prior to generating the first and second SVD based noise images (or at least the first SVD based noise images), the computer subsystem is configured for aligning the first images to a master fame image for the first images thereby generating aligned first images, and the first images for which generating the first SVD based noise images is performed are the aligned first images. For example, the first step in the SVD based cross-layer alignment workflow may include performing global alignment within the current layer in which the test frames are aligned to a master frame. Global alignment in this context refers to aligning entire test frames to the master frame. Local alignment is a finer alignment which aligns smaller blocks of the test frame with those in the master frame. In a job, there are a number of test frames from current and prior layers and also a master frame which is one of the current layer test frames. The goal of the embodiments described herein is to align all the frames within the job to this master frame.

As shown in FIG. 5, for example, raw current images 500 may be input to an alignment step to thereby generate aligned current images 504. The master frame image may be any suitable reference image on the specimen that contains one or more features that are suitable for alignment of images to each other. The first images may be aligned to the master frame image in any suitable manner. In just one example, the first images may be aligned to the master frame image using normalized cross-correlation (NCC) based alignment. Aligning the first images to the master frame image may include aligning only a first portion (not all) of the first images to the master frame image and then aligning a second, different portion of the first images based on the alignment results, e.g., using a coordinate transformation learned from aligning the first portion of the first images to the master frame image. The computer subsystem may therefore align some of the first images to the master frame image and then align others of the first images to the aligned first images.

In one embodiment, generating one of the first SVD based noise images for one of the first images includes SVD of a matrix (A) as a factorization of A into three components as:

$$A = U \sum {V}^{T}$$

wherein columns of U and V are orthogonal rotation matrices and matrix Σ is a diagonal matrix with positive real entries.

In one such embodiment, the matrix Σ contains eigenvalues of the matrix A as diagonal elements, the diagonal elements are singular values representing strength of orthonormal components (e.g., each of the orthonormal components), and generating the one of the first SVD based noise images also includes reconstructing a reduced version of the matrix A with only a predetermined number, k, of the singular values having topmost values and subtracting the reduced version from the one of the first images to thereby generate the one of the first SVD based noise images. For example, truncated SVD works by using only the top k singular values when reconstructing a reduced version of matrix A. This reduced version contains most of the dominant patterns and features from the original test images. Noise images (D) then can be generated by subtracting the reduced version from original test image (T) as follows:

$$D = T - {U}_{r} {\sum }_{r} {V}_{r}^{T}$$

where Uᵣ, Σᵣ, and Vᵣ refer to reduced versions of U, Σ, and V, respectively.

One new feature of the embodiments described herein is that the optimal number of terms to remove may be computed based on noise of the SVD components. This new feature provides significant improvements and advantages to the embodiments described herein including that the amount of noise in SVD generated noise images can be controlled by varying the number of terms to remove. In another such embodiment, the computer subsystem is configured for determining the predetermined number, k, by computing explained variance of the singular values not having the topmost values as:

$${V}_{i} = \frac{{\sum }_{j \geq i} {S}_{j}^{2}}{{\sum }_{j} {S}_{j}^{2}}$$

and selecting the predetermined number as a number of the singular values for which Vᵢ falls below a predetermined threshold. In some such embodiments, the predetermined threshold is 0.1 so that the singular values not having the topmost values contribute less than 10% of total variance in the one of the first images. For example, in an optimal SVD approach, truncated SVD computes noise images by removing the top k components. Hence, the amount of noise is controlled by the parameter k, which can vary for different test images depending on the number of dominant components. The optimal value for k can then be determined by computing explained variance of the remaining components using the above equation. The component for which Vᵢ falls below the 0.1 threshold is selected as the value of k. This condition translates to removing the top k components such that the remaining components contribute less than 10% of the total variance, essentially removing most of the pattern from the test images. The optimal k value may be computed from one of the current layer frames.

Generating SVD based noise images for the (aligned or not) current layer frames as well as raw (unaligned) prior layer frames may be performed as described above. For example, in another embodiment, generating one of the second SVD based noise images for one of the second images includes SVD of a matrix (A) as a factorization of A into three components as:

$$A = U \sum {V}^{T}$$

wherein columns of U and V are orthogonal rotation matrices and matrix Σ is a diagonal matrix with positive real entries.

In one such embodiment, the matrix Σ contains eigenvalues of the matrix A as diagonal elements, the diagonal elements are singular values representing strength of orthonormal components, and generating the one of the second SVD based noise images also includes reconstructing a reduced version of the matrix A with only a predetermined number, k, of the singular values having topmost values and subtracting the reduced version from the one of the second images to thereby generate the one of the second SVD based noise images.

As described above, the optimal k value may be computed from one of the current layer frames. This same k value may be also used for generating the second SVD noise based images. However, a k value may be separately determined for generating the second SVD based noise images. For example, in another such embodiment, the computer subsystem is configured for determining the predetermined number, k, by computing explained variance of the singular values not having the topmost values as:

$${V}_{i} = \frac{{\sum }_{j \geq i} {S}_{j}^{2}}{{\sum }_{j} {S}_{j}^{2}}$$

and selecting the predetermined number as a number of the singular values for which Vᵢ falls below a predetermined threshold. In some such embodiments, the predetermined threshold is 0.1 so that the singular values not having the topmost values contribute less than 10% of total variance in the one of the second images. Each of these steps may be otherwise performed as described further herein.

The computer subsystem is also configured for computing one or more global offsets by aligning the first SVD based noise images to the second SVD based noise images. In other words, the computer subsystem computes global offsets by aligning corresponding noise images from the prior layer to those of the current layer. For example, as shown in FIG. 4, first SVD based noise images 404 and second SVD based noise images 406 are input to alignment step 408 to generate global offsets 410. In another example, as shown in FIG. 5, the computer subsystem may be configured for performing alignment 510 to align current SVD noise images 506 to prior SVD noise images 508. The alignment shown in FIG. 5 may also generate one or more global offsets (not shown in FIG. 5).

Aligning the first SVD based noise images to the second SVD based noise images (or vice versa) may be performed in any suitable manner known in the art such as NCC, which may be performed in any manner known in the art. Although NCC may be commonly used by the embodiments described herein to perform the first and second SVD based noise image alignment, this alignment step may be performed using any other correlation type algorithm or method known in the art. In other words, although NCC is one particularly suitable way to align the first and second SVD based noise images described herein, the first and second SVD based noise images may be input to any suitable alignment method or algorithm for the aligning step described herein.

In one embodiment, prior to generating the first and second SVD based noise images and computing the one or more global offsets, the computer subsystem does not align the second images to a reference. For example, one of the advantages of the embodiments described herein is that the first and second images do not have to be pre-aligned to a reference before being aligned based on correlated noise as described herein. In this manner, a significant advantage of the embodiments described herein is that they have no prerequisite for image alignment within layer for SVD based alignment. In other words, the second images do not have to be aligned to a reference on the specimen or each other. In addition, as described further herein, the embodiments may or may not align the first images to a reference on the specimen or each other prior to SVD. For example, if a currently used process includes aligning the first images to some reference so that they are aligned within layer, the within layer alignment of the first images may be performed since that step is already in the process, but it is not necessary. Eliminating the within-layer image alignment can make the cross-layer alignment described herein faster and easier than the alignment performed by other currently used methods and systems.

The computer subsystem is further configured for applying the one or more global offsets to the second images to thereby align the second images to the first images. In this manner, the determined offsets may be directly applied to prior layer images to achieve cross-layer alignment. As shown in FIG. 4, for example, the computer subsystem may apply global offsets 410 to the second images in step 412 thereby producing output 414 that includes second images aligned to the first images. In addition, as shown in FIG. 5, the computer subsystem may apply global offsets to raw prior images 502 thereby generating aligned prior images 514 that are aligned to raw current images 500 and/or aligned current images 504. In this manner, the computer subsystem generates aligned prior images 514 and aligned current images 512.

In some embodiments, applying the one or more global offsets, which are determined from aligning the first and second SVD based noise images to each other, to the second images thereby aligns the second images to the first images with sub-pixel accuracy. “Sub-pixel” as that term is used herein is generally defined as smaller than a pixel of output generated by an imaging subsystem. In this manner, “sub-pixel accuracy” as that term is used herein can be generally defined as the determination of something (e.g. image alignment) with an error smaller than the size (distance from one side to the other) of a single pixel in an image acquired by the imaging subsystem. The steps described herein enable the cross-layer image alignment to be performed with sub-pixel accuracy. In other words, the steps can be performed as described herein to thereby align different layer images with sub-pixel accuracy.

In one embodiment, generating the first and second SVD based noise images, computing the one or more global offsets, and applying the one or more global offsets are performed separately for a first pair of the first and second images and a second pair of the first and second images. Each pair of the first and second images may include first and second images generated at the same area of the specimen, i.e., a first image generated in first area and a second image generated in the first area. The first and second images in each pair may have any suitable image sizes, e.g., patch images, frame images, etc., which may vary depending on the process being performed on the specimen and the imaging subsystem configuration used for generating the images. In this manner, the embodiments described herein may be configured for separately performing the steps described herein for relatively small images (relative to the size of all of the images generated by the imaging subsystem for the different layers) in pairs defined based on specimen area.

The only images used to align first and second images in a pair generated in the same specimen area are, therefore, those first and second images (and not images from other areas on the specimen, images generated from a database, etc.). This feature provides significant improvements and advantages over currently used methods and systems for cross-layer image alignment. For example, SVD based alignment described herein can be used for single cross-layer image pairs whereas currently used difference image-based alignment requires at least a few test images to generate a difference image.

The SVD based alignment described herein can also advantageously be performed for as few or as many image pairs as selected, e.g., by a user, in a recipe, etc. For example, the SVD based alignment described herein may be performed for each first and second layer image pair for which defect detection will be performed for the first layer (i.e., for the image pair corresponding to each first layer test image). In another example, for relatively well-controlled fabrication processes and/or imaging processes, the SVD based alignment may be performed for substantially fewer pairs than for less well-controlled fabrication and/or imaging processes. The SVD based alignment described herein may also be performed for different images pairs in different areas on the specimen (e.g., in each die on the specimen) or in different portions of the entirety of the images (e.g., in each frame of images generated by the imaging subsystem, in one out of every x frames of images generated by the imaging subsystem, in each swath of images generated by the imaging subsystem, in one out of every y swaths of images generated by the imaging subsystem, and so on). The different pairs of images for which SVD based alignment is performed as described herein may otherwise be determined in the same manner as any other image alignment process known in the art.

The computer subsystem is also configured for determining information for the specimen based on the aligned first and second images, e.g., as shown in step 416 of FIG. 4. The information that is determined by the computer subsystem will vary depending on the process that is being performed on the specimen. In general though, once the first and second images have been aligned to each other as described herein, the first and second images may be input to any method or algorithm that is configured for determining information for a specimen from images of different layers on the specimen. In other words, the images described herein may be used in the same manner as any other images for determining information for the specimen.

The computer subsystem may also be configured for determining information for the specimen based on the aligned first and second images and any other images or information determined by the embodiments described herein. For example, it is possible that one or more of the SVD based noise images may be useful (in combination with the aligned first and second images) for determining information for the specimen. In one such example, although the SVD based noise images may primarily contain noise that is useful for alignment but generally not useful for determining information for specimens, the noise information in the SVD based noise images may be used to determine one or more parameters used for determining the information for the specimen. In the case of inspection, for example, the SVD based noise images may be used for setting one or more defect detection thresholds for the detecting defects step, determining one or more defect attributes such as noisiness of the defect location and/or the area in which the defects are located, and the like.

In one embodiment, determining the information includes detecting defects on the specimen based on the aligned first and second images. For example, the embodiments described herein may be configured for performing an inspection process for the specimen. Unlike most inspection methods that use images from only the current layer (or the layer being inspected), however, the embodiments described herein may use the images from different layers that have been aligned to each other as described herein to detect defects on the specimen. In other words, most currently used inspection methods are single layer inspections where images from one layer are acquired, then the images are processed and defect detection is performed on the processed images. In contrast, the embodiments described herein may perform a multi-layer (2-layer) inspection mode. In this inspection mode, images are acquired for different layers (or steps), then the 2 sets of images are processed together after the alignment described herein to get better defect detection performance. In this manner, the first and second images are aligned as described herein before any other image processing.

Detecting defects on the specimen based on the aligned first and second images may include inputting the aligned first and second images, and possibly any other images or information generated as described herein, into any suitable defect detection method or algorithm known in the art. Preferably, the defect detection method or algorithm is configured to detect defects based on multi-layer images, and possibly other information and images described herein. The defect detection method may use the aligned first and second images for defect detection in a number of possible ways. For example, a multi-layer based plot of the corresponding signals in the aligned first and second images may be generated by the computer subsystem and then the computer subsystem may apply one or more defect detection thresholds to the plot to separate the potential defect signals from non-defect signals.

In another example, defects may be detected on the first layer using any suitable defect detection method known in the art, and then the signals from the locations in the second layer images corresponding to the locations of the defects detected in the first layer, identifiable by the alignment of the second layer images to the first layer images, may be used to separate actual defects from nuisances or noise. In one such example, if significant noise is present at a second image location corresponding to a defect detected in a first layer image, that information may be used to downgrade a detected defect from a defect candidate to an unlikely defect candidate or perhaps even nuisance or noise, depending on the second layer noise (since the noise in the second image may have contributed to the detection of the defect in the first image, rather than there actually being a defect in the first image).

In this manner, the aligned first and second images may be used in combination for the detecting defects step, or only the first images may be used for the detecting defects step, and then the second images may be used to separate the defect candidates into actual (or likely) defect candidates and not (or less likely) defect candidates.

The embodiments described herein may also or alternatively be configured for performing a metrology process for the specimen. For example, the first and second layer images that have been aligned to each other may be input to a measurement method or algorithm, which may be performed by the embodiments described herein. Aligning images of different layers to each other may be performed during metrology to determine relative characteristics such as overlay of features on one layer to features on another layer (i.e., relative position of features on one layer to features on a different layer). In this manner, the differences between positions of features in the first and second aligned images can be determined, which for metrology purposes can be used to monitor the performance of a process performed on the specimen, can be used to identify a problem in such a fabrication process, can be used to determine corrections to such a fabrication process, etc. Such processes and corrections are described further herein.

The embodiments described herein may be configured for performing a defect review process for the specimen. In this manner, the aligned first and second layer images may be used for re-detecting defects detected in inspection and possibly determining additional information for the defects, which may be performed by the embodiments described herein. For example, once a defect has been redetected in defect review, the aligned portions of the first and second layer images corresponding to the defect may be used to determine additional information for the defect than has been determined by inspection and/or information determined at a higher resolution than that which has been determined by inspection. In one such example, since defect review images are generated at a higher resolution than inspection images, more accurate and/or detailed information can be determined by defect review compared to inspection. The defect information that can be determined from the aligned first and second images described herein may also be more accurate and/or detailed since the aligned first and second images can, at least in part, be used for this purpose. In some instances, it may also be useful to use any other images and/or information generated as described herein to determine one or more characteristics of a defect redetected by review. Defect review may otherwise be performed in any suitable manner known in the art using at least the aligned first and second layer images.

The computer subsystem may also be configured for generating results that include the determined information, which may include any of the results or information described herein. The results of determining the information may be generated by the computer subsystem in any suitable manner. All of the embodiments described herein may be configured for storing results of one or more steps of the embodiments in a computer-readable storage medium. The results may include any of the results described herein and may be stored in any manner known in the art. The results that include the determined information may have any suitable form or format such as a standard file type. The storage medium may include any storage medium described herein or any other suitable storage medium known in the art.

After the results have been stored, the results can be accessed in the storage medium and used by any of the method or system embodiments described herein, formatted for display to a user, used by another software module, method, or system, etc. to perform one or more functions for the specimen or another specimen of the same type. In addition, the results may include any information for the specimen determined as described herein.

That information may be used by the computer subsystem or another system or method for performing additional functions for the specimen. Such functions include, but are not limited to, altering a process such as a fabrication process or step that was or will be performed on the specimen in a feedback or feedforward manner, etc. For example, the computer subsystem may be configured to determine one or more changes to a process that was performed on the specimen and/or a process that will be performed on the specimen based on the determined information. The changes to the process may include any suitable changes to one or more parameters of the process. In one such example, the computer subsystem preferably determines those changes such that any determined specimen information that is outside of an acceptable range of values is corrected on other specimens on which the revised process is performed, is corrected on the specimen in another process performed on the specimen, is compensated for in another process performed on the specimen, etc. The computer subsystem may determine such changes in any suitable manner known in the art. The computer subsystem may also alter the fabrication process based on the determined changes in any suitable manner, e.g., by altering a recipe used to perform the fabrication process on the specimen or one or more other specimens.

Those changes can then be sent to a semiconductor fabrication system (not shown) or a storage medium (not shown) accessible to both the computer subsystem and the semiconductor fabrication system. The semiconductor fabrication system may or may not be part of the system embodiments described herein. For example, the imaging subsystem and/or the computer subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

The embodiments described herein provide a number of important improvements and advantages over previously used methods and systems for image alignment that are provided by one or more new features of the embodiments described herein. One advantage of SVD based cross-layer alignment over currently used difference image-based alignment is that, in the case of the SVD based alignment described herein, images have no prerequisite to be aligned within layer. Another advantage is that the amount of noise in SVD generated noise images can be controlled by varying the number of terms that are removed. An additional advantage is that SVD can remove medium to large size defects from noise images that have the potential to cause misalignment, as they can in the currently used difference image based alignment.

SVD based alignment can also be advantageously used for single cross-layer image pairs whereas currently used difference image-based alignment requires at least a few test images to generate difference images. SVD based alignment can also advantageously handle repeating patterns in the test images. Furthermore, several features require alignment of test images that may be poorly correlated due to several factors such as the use of different wafer layers or different optical modes, etc. In addition, repeating patterns in the test images can pose challenges to raw image-based alignment. SVD based alignment can help address the alignment challenges in such cases and improve overall performance of defect detection algorithms.

Each of the embodiments of each of the systems described above may be combined together into one single embodiment.

Another embodiment relates to a computer-implemented method for aligning images of different layers on a specimen. The method includes acquiring first and second images (e.g., 400 and 402, FIG. 4) generated by an imaging subsystem (e.g., 10, FIG. 1) of first and second layers (e.g., 302 and 310, FIG. 3), respectively, on a specimen (14, FIG. 1). The first layer is formed on the specimen subsequent to formation of the second layer on the specimen. The method also includes generating first and second SVD based noise images (404 and 406, FIG. 4) for the first images and the second images, respectively. In addition, the method includes computing one or more global offsets (410) by aligning (in step 408) the first SVD based noise images to the second SVD based noise images. The method further includes applying the one or more global offsets to the second images (in step 412) to thereby align the second images to the first images (i.e., second images aligned to the first images 414) and determining information for the specimen based on the aligned first and second images (in step 416).

Each of the steps of the method may be performed as described further herein. The method may also include any other step(s) that can be performed by the imaging subsystem, computer subsystem, or system described herein. The acquiring, generating, computing, applying, and determining steps are performed by a computer subsystem coupled to the imaging subsystem, all of which may be configured according to any of the embodiments described herein. In addition, the method described above may be performed by any of the system embodiments described herein.

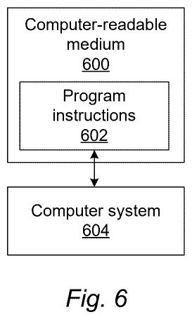

An additional embodiment relates to a non-transitory computer-readable medium storing program instructions executable on a computer system for performing a computer-implemented method for aligning images of different layers on a specimen. One such embodiment is shown in FIG. 6. In particular, as shown in FIG. 6, non-transitory computer-readable medium 600 includes program instructions 602 executable on computer system 604. The computer-implemented method may include any step(s) of any method(s) described herein.

Program instructions 602 implementing methods such as those described herein may be stored on computer-readable medium 600. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 604 may be configured according to any of the embodiments described herein.

Further modifications and alternative embodiments of various aspects of the invention will be apparent to those skilled in the art in view of this description. For example, methods and systems for aligning images of different layers on a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for aligning images of different layers on a specimen, comprising:
an imaging subsystem configured to generate first and second images of first and second layers, respectively, on a specimen, wherein the first layer is formed on the specimen subsequent to formation of the second layer on the specimen; and
a computer subsystem configured for:
generating first and second singular value decomposition (SVD) based noise images for the first images and the second images, respectively;
computing one or more global offsets by aligning the first SVD based noise images to the second SVD based noise images;
applying the one or more global offsets to the second images to thereby align the second images to the first images; and
determining information for the specimen based on the aligned first and second images.

2. The system of claim 1, wherein the first and second images comprise images of different patterned features on the specimen having at least one different patterned feature characteristic in addition to being formed on different layers of the specimen.

3. The system of claim 1, wherein the second layer is formed under the first layer.

4. The system of claim 1, wherein the second layer contributes to noise in the first images.

5. The system of claim 1, wherein noise in the first images is correlated with noise in the second images.

6. The system of claim 1, wherein generating one of the first SVD based noise images for one of the first images comprises SVD of a matrix (A) as a factorization of A into three components as:
$$A = U \sum {V}^{T}$$
where columns of U and V are orthogonal rotation matrices and matrix Σ is a diagonal matrix with positive real entries.

7. The system of claim 6, wherein the matrix Σ contains eigenvalues of the matrix A as diagonal elements, wherein the diagonal elements are singular values representing strength of orthonormal components, and wherein generating the one of the first SVD based noise images further comprises reconstructing a reduced version of the matrix A with only a predetermined number, k, of the singular values having topmost values and subtracting the reduced version from the one of the first images to thereby generate the one of the first SVD based noise images.

8. The system of claim 7, wherein the computer subsystem is further configured for determining the predetermined number, k, by computing explained variance of the singular values not having the topmost values as:
$${V}_{i} = \frac{{\sum }_{j \geq i} {S}_{j}^{2}}{{\sum }_{j} {S}_{j}^{2}}$$
and selecting the predetermined number as a number of the singular values for which Vᵢ falls below a predetermined threshold.

9. The system of claim 8, wherein the predetermined threshold is 0.1 so that the singular values not having the topmost values contribute less than 10% of total variance in the one of the first images.

10. The system of claim 1, wherein generating one of the second SVD based noise images for one of the second images comprises SVD of a matrix (A) as a factorization of A into three components as:
$$A = U \sum {V}^{T}$$
where columns of U and V are orthogonal rotation matrices and matrix Σ is a diagonal matrix with positive real entries.

11. The system of claim 10, wherein the matrix Σ contains eigenvalues of the matrix A as diagonal elements, wherein the diagonal elements are singular values representing strength of orthonormal components, and wherein generating the one of the second SVD based noise images further comprises reconstructing a reduced version of the matrix A with only a predetermined number, k, of the singular values having topmost values and subtracting the reduced version from the one of the second images to thereby generate the one of the second SVD based noise images.

12. The system of claim 11, wherein the computer subsystem is further configured for determining the predetermined number, k, by computing explained variance of the singular values not having the topmost values as:
$${V}_{i} = \frac{{\sum }_{j \geq i} {S}_{j}^{2}}{{\sum }_{j} {S}_{j}^{2}}$$
and selecting the predetermined number as a number of the singular values for which Vᵢ falls below a predetermined threshold.

13. The system of claim 12, wherein the predetermined threshold is 0.1 so that the singular values not having the topmost values contribute less than 10% of total variance in the one of the second images.

14. The system of claim 1, wherein prior to said generating, the computer subsystem is further configured for aligning the first images to a master frame image for the first images thereby generating aligned first images, and wherein the first images for which generating the first SVD based noise images is performed are the aligned first images.

15. The system of claim 1, wherein prior to said generating and said computing, the computer subsystem does not align the second images to a reference.

16. The system of claim 1, wherein generating the first and second SVD based noise images removes medium-sized or larger defects in the first and second images from the first and second SVD based noise images, respectively.

17. The system of claim 1, wherein generating the first and second SVD based noise images removes repeating patterns in the first and second images from the first and second SVD based noise images, respectively.

18. The system of claim 1, wherein said generating, computing, and applying are performed separately for a first pair of the first and second images and a second pair of the first and second images.

19. The system of claim 1, wherein determining the information comprises detecting defects on the specimen based on the aligned first and second images.

20. The system of claim 1, wherein the imaging subsystem is a broadband light-based imaging subsystem.

21. A non-transitory computer-readable medium, storing program instructions executable on a computer system for performing a computer-implemented method for aligning images of different layers on a specimen, wherein the computer-implemented method comprises:
acquiring first and second images generated by an imaging subsystem of first and second layers, respectively, on a specimen, wherein the first layer is formed on the specimen subsequent to formation of the second layer on the specimen;
generating first and second SVD based noise images for the first images and the second images, respectively;
computing one or more global offsets by aligning the first SVD based noise images to the second SVD based noise images;
applying the one or more global offsets to the second images to thereby align the second images to the first images; and
determining information for the specimen based on the aligned first and second images.

22. A computer-implemented method for aligning images of different layers on a specimen, comprising:
acquiring first and second images generated by an imaging subsystem of first and second layers, respectively, on a specimen, wherein the first layer is formed on the specimen subsequent to formation of the second layer on the specimen;
generating first and second SVD based noise images for the first images and the second images, respectively;
computing one or more global offsets by aligning the first SVD based noise images to the second SVD based noise images;
applying the one or more global offsets to the second images to thereby align the second images to the first images; and
determining information for the specimen based on the aligned first and second images, wherein said acquiring, generating, computing, applying, and determining are performed by a computer subsystem coupled to the imaging subsystem.
